(19) United States
(12) Patent Application Publication
(10) Pub. No.: US 2010/0093532 A1
(43) Pub. Date: Apr. 15, 2010

(54) Pesticidal Mixtures Comprising Phenylsemicarbazone and Clothianidin

(75) Inventors: Dirk Voeste, Limburgerhof (DE); Egon Haden, Kleinniedesheim (DE); Hassan Oloumi-Sadeghi, Raleigh, NC (US)

Correspondence Address: BRINKS, HOFER, GILSON & LIONE, P.O. BOX 1340, MORRISVILLE, NC, 27560, US

(73) Assignee: BASF SE, Ludwigshafen (DE)

(21) Appl. No.: 12/525,593

(22) PCT Filed: Feb. 1, 2008
(86) PCT No.: PCT/EP08/51271

§ 371 Date: Aug. 3, 2009

Related U.S. Application Data
(60) Provisional application No. 60/888,121, filed on Feb. 5, 2007.

(51) Int. Cl. A01C 1/06; A01N 43/78

(52) U.S. Cl. 504/100; 514/365

(57) ABSTRACT

This invention relates to a pesticidal mixture comprising, as active components, 1) a phenylsemicarbazone compound of the Formula (I) wherein R¹ and R² are each independently hydrogen, halogen, cyano, C₁-C₄alkyl, C₁-C₄alkoxy, C₁-C₄haloalkyl or C₁-C₄haloalkoxy and R³ is C₁-C₄alkoxy, C₁-C₄haloalkyl or C₁-C₄haloalkoxy, or an agriculturally acceptable salt thereof; and 2) a compound of the Formula (II) or its agriculturally acceptable salts, in synergistically effective amounts.

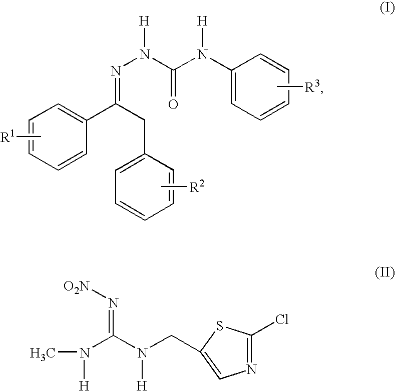

The invention relates to mixtures comprising insecticidal phenylsemicarbazones of the formula I as defined hereinafter and the use of such mixtures for controlling insect pests.

In spite of the commercial insecticides, acaricides and nematicides available today, damage to crops, both growing and harvested, caused by insects, arachnids and nematodes still occurs. Therefore, there is a continuing need to develop new insecticidal, acaricidal and nematicidal agents.

One typical problem arising in the field of pest control lies in the need to reduce the dosage rates of the active ingredient in order to reduce or avoid unfavorable environmental or toxicological effects whilst still allowing effective pest control.

Another problem encountered concerns the need to have available pest control agents which are effective against a broad spectrum of pests.

There also exists the need for pest control agents that combine knock-down activity with prolonged control, that is, fast action with long lasting action.

Another difficulty in relation to the use of pesticides is that the repeated and exclusive application of an individual pesticidal compound leads in many cases to a rapid selection of pests which have developed natural or adapted resistance against the active compound in question. Therefore there is a need for pest control agents that help prevent or overcome resistance.

It was therefore an object of the present invention to provide new pesticidal agents and new methods for the control of insects, arachnids or nematodes and of protecting growing plants from attack or infestation by insects, arachnids or nematodes and also new methods for the protection of seeds from insects.

It was another object of the invention to provide pesticidal agents which solve the problems of reducing the dosage rate and/or enhancing the spectrum of activity and/or combining knock-down activity with prolonged control and/or to resistance management.

The phenylsemicarbazones of formula (I), their preparation and their action against arthropods are known from EP-A 0 462 456.

WO 00/54591 discloses insecticidal compositions comprising the phenylsemicarbazones of formula (I) in combination with certain insecticidal compounds.

US 2004/0063703 A1 discloses mixtures comprising synergistic mixtures comprising one or more sodium ion channel effectors and the compound (Z)-3-(6-chloro-3-pyridylmethyl)-1,3-thiazblidin-2-ylidenecyanamide or the compound (E)-1-(2-chloro-1,3-thiazol-5-ylmethyl)-3-methyl-2-nitroguanidine or the compound 1-[(6-chloro-3-pyridinyl)methyl]-N-nitro-2-imidazolidineimine and the use of these mixtures for controlling animal pests. The sodium ion channel effector may be, inter alia, a phenylsemicarbazone compound of the formula (I) as defined in this reference.

JP 2006131515 A discloses pesticidal compositions comprising, as active components, a hydrazinecarboxamide compound which is 2-[2-(4-cyanophenyl)-1-[3-(trifluoromethyl)phenyl]ethylidene]-N-[4-(trifluoromethoxy)phenyl]hydrazinecarboxamide and a compound selected from a broad range of compounds having insecticidal, acaricidal or nematodicidal activity, inter alia clothianidin.

The compounds and compositions disclosed in the above-mentioned references do not always show a completely satisfactory performance with respect to the above-mentioned problems. A synergistic effect obtained by combining the phenylsemicarbazones of formula I with clothianidin has not been disclosed therein.

Surprisingly, it has now been found that, by mixing the phenylsemicarbazones of formula I with the active compound clothianidin, the objects of the invention can be achieved at least in certain aspects.

Accordingly, in one aspect of the invention there is provided a pesticidal mixture comprising, as active components,

1) a phenylsemicarbazone compound of the formula I

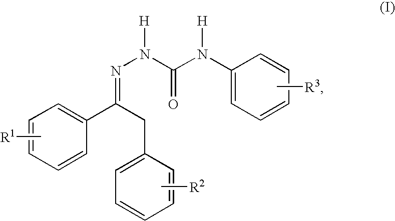

wherein R¹ and R² are each independently hydrogen, halogen, cyano, C₁-C₄ alkyl, C₁-C₄ alkoxy, C₁-C₄ haloalkyl or C₁-C₄ haloalkoxy and R³ is C₁-C₄ alkoxy, C₁-C₄ haloalkyl or C₁-C₄ haloalkoxy, or an agriculturally acceptable salt thereof; and

2) a compound of the formula II

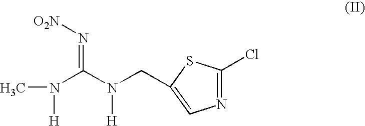

or its agriculturally acceptable salts, in synergistically effective amounts.

The common name of the compound of formula II is clothianidin, i.e. (E)-1-(2-chloro-1,3-thiazol-5-ylmethyl)-3-methyl-2-nitroguanidine.

Moreover, this invention relates to a method for controlling pests, using mixtures of a compound I with compound II, to compositions comprising such mixtures and to a method for preparing such compositions.

As used herein, the term “pest” is considered to include any harmful organisms including insects, acarids, and nematodes.

The present invention also provides a method for the control of insects, acarids or nematodes comprising contacting the insect, acarid or nematode or their food supply, habitat, breeding grounds or their locus with a pesticidally effective amount of a mixtures of a compound I with the compound II.

In another embodiment, the present invention relates to a method for protecting plants from attack or infestation by insects, acarids or nematodes comprising contacting the plant, or the soil or water in which the plant is growing, with a pesticidally effective amount of a mixture of a compound I with the compound II.

Further, this invention relates to the use of a mixture of a compound I with the compound II for the protection of seeds and to a method of protection of seed comprising contacting the seeds before sowing and/or after pregermination with the inventive mixture.

This invention also provides a method for treating, controlling, preventing or protecting a warm-blooded animal or fish against infestation or infection by pests which comprises orally, topically or parenterally administering or applying to the animal or fish a pesticidally effective amount of a mixture of a compound I with the compound II.

The invention also provides a process for the preparation of a composition for treating, controlling, preventing or protecting a warm-blooded animal or a fish against infestation or infection by pests which comprises a pesticidally effective amount of a mixture of a compound I with the compound II.

The term “C₁-C₄alkyl”, as used herein as such as well as in related terms, such as C₁-C₄ alkoxy, C₁-C₄ haloalkyl or C₁-C₄ haloalkoxy, refers to straight or branched aliphatic alkyl groups having from 1 to 4 carbon atoms, e.g. methyl, ethyl, propyl, isopropyl, n-butyl, sec-butyl and tert-butyl.

The term “halogen”, as used herein as such as well as in related terms, such as “haloalkyl” or “haloalkoxy”, is selected from fluorine, chlorine, iodine and bromine, preferably from fluorine and chlorine, and more preferably is fluorine.

The term “C₁-C₄alkoxy” as used herein refers to a C₁-C₄ alkyl group, as defined above, which is linked via an oxygen atom, e.g. methoxy, ethoxy, propoxy, isopropoxy, n-butoxy, sec-butoxy and tert-butoxy.

The term “C₁-C₄ haloalkyl” as used herein refers to a C₁-C₄ alkyl group, as defined above, which additionally contains one or more, e.g. 2, 3, 4, 5 or 6, halogen atom(s), as defined above, e.g. mono- di- and trifluoromethyl, mono-, di- and trichloromethyl, 1-fluoroethyl, 1-chloroethyl, 2-fluoroethyl, 2-chloroethyl, 1,1-difluoroethyl, 1,1-dichloroethyl, 1,2-difluoroethyl, 1,2-dichloroethyl, 2,2-difluoroethyl, 2,2-dichloroethyl, 2,2,2-trifluoroethyl and 2,2,2-trichloroethyl.

The term “C₁-C₄ haloalkoxy” as used herein refers to a C₁-C₄alkoxy group, as defined above, which additionally contains one or more, e.g. 2, 3, 4, 5 or 6, halogen atom(s), as defined above, e.g. mono- di- and trifluoromethoxy, mono- di- and trichloromethoxy, 1-fluoroethoxy, 1-chloroethoxy, 2-fluoroethoxy, 2-chloroethoxy, 1,1-difluoroethoxy, 1,1-dichloroethoxy, 1,2-difluoroethoxy, 1,2-dichloroethoxy, 2,2-difluoroethoxy, 2,2-dichloroethoxy, 2,2,2-trifluoroethoxy and 2,2,2-trichloroethoxy.

In another embodiment of this invention, the substituents R¹, R² and R³ in the formula (I) independently of one another, but in particular in combination, have the meanings given below:

R¹ is C₁-C₄ haloalkyl, in particular trifluoromethyl;

R² is cyano;

R³ is C₁-C₄ haloalkoxy, in particular trifluoromethoxy.

A preferred compound of the formula (I) is one wherein R¹ is 3-CF₃ (i.e. CF₃ which is disposed in the meta position), R² is 4-CN (i.e. CN which is disposed in the para position) and R³ is 4-OCF₃ (OCF₃ which is disposed in the para position), i.e. metaflumizone. Metaflumizone is the common name for 2-[2-(4-cyanophenyl)-1-[3-(trifluoromethyl)phenyl]ethylidene]-N-[4-(trifluoromethoxy)phenyl]hydrazinecarboxamide (IUPAC nomenclature: (EZ)-2′-[2-(4-cyanophenyl)-1-(α,α,α-trifluoro-m-tolyl)ethylidene]-4-(trifluoromethoxy)carbanilohydrazide), having the following formula Ia:

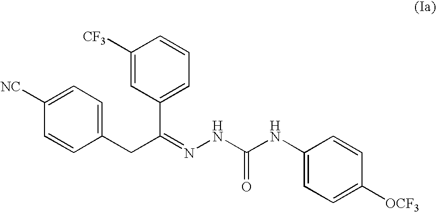

The compound Ia exists in two geometric isomers with regard to the C—N double bond, i.e. 4-{(2E)-2-({[4-(trifluoromethoxy)anilino]carbonyl}hydrazono)-2-[3-(trifluoromethyl)-phenyl]ethyl}benzonitrile and 4-{(2Z)-2-({[4-(trifluoromethoxy)anilino]carbonyl}-hydrazono)-2-3-(trifluoromethyl)phenyl]ethyl}benzonitrile. It is to be understood that the term metaflumizone includes both the E- and Z-isomer of the compound as defined above, as well as any mixture thereof in any ratio. E- and Z-isomers of compounds I and Ia and their interconversion have been described in general in WO05/047235, incorporated herein by reference. In particular, reference is made to the description of the above geometric isomers of metaflumizone, which WO05/047235 refers to as I-E and I—Z (or I.1-E and I.1-Z), their synthesis and conversion (examples 1 to 3 of WO05/047235) as well as mixtures of the E- and Z-isomer, especially with high E/Z-ratio. Because the pesticidal activity of the E-isomer is generally higher than that of the Z-isomer, metaflumizone having a E/Z-ratio higher than 1:1 may be preferred.

Clothianidin of formula (II), its preparation and its pesticidal activity are likewise known from the literature (cf. EP-A 376 279 and EP-A 375 907).

Preferably, the mixture of the invention is a mixture of compound Ia (metaflumizone) and compound II (clothianidin).

Preferably, the mixture of the invention comprises components (1) and (2) in synergistically effective amounts.

Preferably, the mixture of the invention comprises components (1) and (2) in a synergistically effective ratio.

When preparing the mixtures, it is preferred to employ the pure active compounds (I) and (II), to which further active compounds, also against harmful fungi or else herbicidal or growth-regulating active compounds or fertilizers can be added.

The mixtures of compounds (I) and (II) or the simultaneous or successive use of the compounds (I) and (II) exhibit outstanding action against pests from the following orders:

insects from the order of the lepidopterans (Lepidoptera), for example Agrotis ypsilon, Agrotis segetum, Alabama argillacea, Anticarsia gemmatalis, Argyresthia conjugella, Autographa gamma, Bupalus piniarius, Cacoecia murinana, Capua reticulana, Cheimatobia brumata, Choristoneura fumiferana, Choristoneura occidentalis, Cirphis unipuncta, Cydia pomonella, Dendrolimus pini, Diaphania nitidalis, Diatraea grandiosella, Earias insulana, Elasmopalpus lignosellus, Eupoecilia ambiguella, Evetria bouliana, Feltia subterranea, Galleria mellonella, Grapholitha funebrana, Grapholitha molesta, Heliothis armigera, Heliothis virescens, Heliothis zea, Hellula undalis, Hibernia defoliaria, Hyphantria cunea, Hyponomeuta malinellus, Keiferia lycopersicella, Lambdina fiscellaria, Laphygma exigua, Leucoptera coffeella, Leucoptera scitella, Lithocolletis blancardella, Lobesia botrana, Loxostege sticticalis, Lymantria dispar, Lymantria monacha, Lyonetia clerkella, Malacosoma neustria, Mamestra brassicae, Orgyia pseudotsugata, Ostrinia nubilalis, Panolis flammea, Pectinophora gossypiella, Peridroma saucia, Phalera bucephala, Phthorimaea operculella, Phyllocnistis citrella, Pieris brassicae, Plathypena scabra, Plutella xylostella, Pseudoplusia includens, Rhyacionia frustrana, Scrobipalpula absoluta, Sitotroga cerealella, Sparganothis pilleriana, Spodoptera frugiperda, Spodoptera littoralis, Spodoptera litura, Thaumatopoea pityocampa, Tortrix viridana, Trichoplusia ni and Zeiraphera canadensis,

beetles (Coleoptera), for example Agrilus sinuatus, Agriotes lineatus, Agriotes obscurus, Amphimallus solstitialis, Anisandrus dispar, Anthonomus grandis, Anthonomus pomorum, Aphthona euphoridae, Athous haemorrhoidalis, Atomaria linearis, Blastophagus piniperda, Blitophaga undata, Bruchus rufimanus, Bruchus pisorum, Bruchus lentis, Byctiscus betulae, Cassida nebulosa, Cerotoma trifurcata, Cetonia aurata, Ceuthorrhynchus assimilis, Ceuthorrhynchus napi, Chaetocnema tibialis, Conoderus vespertinus, Crioceris asparagi, Ctenicera ssp., Diabrotica longicornis, Diabrotica semipunctata, Diabrotica 12-punctata Diabrotica speciosa, Diabrotica virgifera, Epilachna varivestis, Epitrix hirtipennis, Eutinobothrus brasiliensis, Hylobius abietis, Hypera brunneipennis, Hypera postica, Ips typographus, Lema bilineata, Lema melanopus, Leptinotarsa decemlineata, Limonius californicus, Lissorhoptrus oryzophilus, Melanotus communis, Meligethes aeneus, Melolontha hippocastani, Melolontha melolontha, Oulema oryzae, Ortiorrhynchus sulcatus, Otiorrhynchus ovatus, Phaedon cochleariae, Phyllobius pyri, Phyllotreta chrysocephala, Phyllophaga sp., Phyllopertha horticola, Phyllotreta nemorum, Phyllotreta striolata, Popillia japonica, Sitona lineatus and Sitophilus granaria,

flies, mosquitoes (Diptera), e.g. Aedes aegypti, Aedes albopictus, Aedes vexans, Anastrepha ludens, Anopheles maculipennis, Anopheles crucians, Anopheles albimanus, Anopheles gambiae, Anopheles freeborni, Anopheles leucosphyrus, Anopheles minimus, Anopheles quadrimaculatus, Calliphora vicina, Ceratitis capitata, Chrysomya bezziana, Chrysomya hominivorax, Chrysomya macellaria, Chrysops discalis, Chrysops silacea, Chrysops atlanticus, Cochliomyia hominivorax, Contarinia sorghicola Cordylobia anthropophaga, Culicoides furens, Culex pipiens, Culex nigripalpus, Culex quinquefasciatus, Culex tarsalis, Culiseta inornata, Culiseta melanura, Dacus cucurbitae, Dacus oleae, Dasineura brassicae, Delia antique, Delia coarctata, Delia platura, Delia radicum, Dermatobia hominis, Fannia canicularis, Geomyza Tripunctata, Gasterophilus intestinalis, Glossina morsitans, Glossina palpalis, Glossina fuscipes, Glossina tachinoides, Haematobia irritans, Haplodiplosis equestris, Hippelates spp., Hylemyia platura, Hypoderma lineata, Leptoconops torrens, Liriomyza sativae, Liriomyza trifolii, Lucilia caprina, Lucilia cuprina, Lucilia sericata, Lycoria pectoralis, Mansonia titillanus, Mayetiola destructor, Musca domestica, Muscina stabulans, Oestrus ovis, Opomyza florum, Oscinella frit, Pegomya hysocyami, Phorbia antiqua, Phorbia brassicae, Phorbia coarctata, Phlebotomus argentipes, Psorophora columbiae, Psila rosae, Psorophora discolor, Prosimulium mixtum, Rhagoletis cerasi, Rhagoletis pomonella, Sarcophaga haemorrhoidalis, Sarcophaga sp., Simulium vittatum, Stomoxys calcitrans, Tabanus bovinus, Tabanus atratus, Tabanus lineola, and Tabanus similis, Tipula oleracea, and Tipula paludosa

thrips (Thysanoptera), e.g. Dichromothrips corbetti, Dichromothrips ssp, Frankliniella fusca, Frankliniella occidentalis, Frankliniella tritici, Scirtothrips citri, Thrips oryzae, Thrips palmi and Thrips tabaci,

termites (Isoptera), e.g. Calotermes flavicollis, Leucotermes flavipes, Heterotermes aureus, Reticulitermes flavipes, Reticulitermes virginicus, Reticulitermes lucifugus, Termes natalensis, and Coptotermes formosanus, cockroaches (Blattaria—Blattodea), e.g. Blattella germanica, Blattella asahinae, Periplaneta americana, Periplaneta japonica, Periplaneta brunnea, Periplaneta fuligginosa, Periplaneta australasiae, and Blatta orientalis,

true bugs (Hemiptera), e.g. Acrosternum hilare, Blissus leucopterus, Cyrtopeltis notatus, Dysdercus cingulatus, Dysdercus intermedius, Eurygaster integriceps, Euschistus impictiventris, Leptoglossus phyllopus, Lygus lineolaris, Lygus pratensis, Nezara viridula, Piesma quadrata, Solubea insularis , Thyanta perditor, Acyrthosiphon onobrychis, Adelges laricis, Aphidula nasturtii, Aphis fabae, Aphis forbesi, Aphis pomi, Aphis gossypii, Aphis grossulariae, Aphis schneideri, Aphis spiraecola, Aphis sambuci, Acyrthosiphon pisum, Aulacorthum solani, Bemisia argentifolii, Brachycaudus cardui, Brachycaudus helichrysi, Brachycaudus persicae, Brachycaudus prunicola, Brevicoryne brassicae, Capitophorus horni, Cerosipha gossypii, Chaetosiphon fragaefolii, Cryptomyzus ribis, Dreyfusia nordmannianae, Dreyfusia piceae, Dysaphis radicola, Dysaulacorthum pseudosolani, Dysaphis plantaginea, Dysaphis pyri, Empoasca fabae, Hyalopterus pruni, Hyperomyzus lactucae, Macrosiphum avenae, Macrosiphum euphorbiae, Macrosiphon rosae, Megoura viciae, Melanaphis pyrarius, Metopolophium dirhodum, Myzus persicae, Myzus ascalonicus, Myzus cerasi, Myzus varians, Nasonovia ribis-nigri, Nilaparvata lugens, Pemphigus bursarius, Perkinsiella saccharicida, Phorodon humuli, Psylla mali, Psylla piri, Rhopalomyzus ascalonicus, Rhopalosiphum maidis, Rhopalosiphum padi, Rhopalosiphum insertum, Sappaphis mala, Sappaphis mali, Schizaphis graminum, Schizoneura lanuginosa, Sitobion avenae, Trialeurodes vaporariorum, Toxoptera aurantiiand, Viteus vitifolii, Cimex lectularius, Cimex hemipterus, Reduvius senilis, Triatoma spp., and Arilus critatus.

ants, bees, wasps, sawflies (Hymenoptera), e.g. Athalia rosae, Atta cephalotes, Atta capiguara, Atta cephalotes, Atta laevigata, Atta robusta, Atta sexdens, Atta texana, Crematogaster spp., Hoplocampa minuta, Hoplocampa testudinea, Monomorium pharaonis, Solenopsis geminata, Solenopsis invicta, Solenopsis richteri, Solenopsis xyloni, Pogonomyrmex barbatus, Pogonomyrmex californicus, Pheidole megacephala, Dasymutilla occidentalis, Bombus spp. Vespula squamosa, Paravespula vulgaris, Paravespula pennsylvanica, Paravespula germanica, Dolichovespula maculata, Vespa crabro, Polistes rubiginosa, Camponotus floridanus, and Linepithema humile,

crickets, grasshoppers, locusts (Orthoptera), e.g. Acheta domestica, Gryllotalpa gryllotalpa, Locusta migratoria, Melanoplus bivittatus, Melanoplus femurrubrum, Melanoplus mexicanus, Melanoplus sanguinipes, Melanoplus spretus, Nomadacris septemfasciata, Schistocerca americana, Schistocerca gregaria, Dociostaurus maroccanus, Tachycines asynamorus, Oedaleus senegalensis, Zonozerus variegatus, Hieroglyphus daganensis, Kraussaria angulifera, Calliptamus italicus, Chortoicetes terminifera, and Locustana pardalina,

Arachnoidea, such as arachnids (Acarina), e.g. of the families Argasidae, Ixodidae and Sarcoptidae, such as Amblyomma americanum, Amblyomma variegatum, Ambryomma maculatum, Argas persicus, Boophilus annulatus, Boophilus decoloratus, Boophilus microplus, Dermacentor silvarum, Dermacentor andersoni, Dermacentor variabilis, Hyalomma truncatum, Ixodes ricinus, Ixodes rubicundus, Ixodes scapularis, Ixodes holocyclus, Ixodes pacificus, Ornithodorus moubata, Ornithodorus hermsi, Ornithodorus turicata, Ornithonyssus bacoti, Otobius megnini, Dermanyssus gallinae, Psoroptes ovis, Rhipicephalus sanguineus, Rhipicephalus appendiculatus, Rhipicephalus evertsi, Sarcoptes scabiei, and Eriophyidae spp. such as Aculus schlechtendali, Phyllocoptrata oleivora and Eriophyes sheldoni; Tarsonemidae spp. such as Phytonemus pallidus and Polyphagotarsonemus latus; Tenuipalpidae spp. such as Brevipalpus phoenicis; Tetranychidae spp. such as Tetranychus cinnabarinus, Tetranychus kanzawai, Tetranychus pacificus, Tetranychus telarius and Tetranychus urticae, Panonychus ulmi, Panonychus citri, and Oligonychus pratensis; Araneida, e.g. Latrodectus mactans, and Loxosceles reclusa, ticks (Ixodida), e.g. Phipicephalus sanguineus, or mites, such as Mesostigmata, e.g. Ornithonyssus bacoti and Dermanyssus gallinae, Prostigmata, e.g. Pymotes tritici, or Astigmata, e.g. Acarus siro,

fleas (Siphonaptera), e.g. Ctenocephalides felis, Ctenocephalides canis, Xenopsylla cheopis, Pulex irritans, Tunga penetrans, and Nosopsyllus fasciatus,

silverfish, firebrat (Thysanura), e.g. Lepisma saccharina and Thermobia domestica,

centipedes (Chilopoda), e.g. Scutigera coleoptrata,

millipedes (Diplopoda), e.g. Narceus spp.,

Earwigs (Dermaptera), e.g. forficula auricularia,

lice (Phthiraptera), e.g. Pediculus humanus capitis, Pediculus humanus corporis, Pthirus pubis, Haematopinus eurysternus, Haematopinus suis, Linognathus vituli, Bovicola bovis, Menopon gallinae, Menacanthus stramineus and Solenopotes capillatus.

Plant parasitic nematodes such as root-knot nematodes, Meloidogyne arenaria, Meloidogyne chitwoodi, Meloidogyne exigua, Meloidogyne hapla, Meloidogyne incognita, Meloidogyne javanica and other Meloidogyne species; cyst nematodes, Globodera rostochiensis, Globodera pallida, Globodera tabacum and other Globodera species, Heterodera avenae, Heterodera glycines, Heterodera schachtii, Heterodera trifolii, and other Heterodera species; seed gall nematodes, Anguina funesta, Anguina tritici and other Anguina species; stem and foliar nematodes, Aphelenchoides besseyi, Aphelenchoides fragariae, Aphelenchoides ritzemabosi and other Aphelenchoides species; sting nematodes, Belonolaimus longicaudatus and other Belonolaimus species; pine nematodes, Bursaphelenchus xylophilus and other Bursaphelenchus species; ring nematodes, Criconema species, Criconemella species, Criconemoides species, and Mesocriconema species; stem and bulb nematodes, Ditylenchus destructor, Ditylenchus dipsaci, Ditylenchus myceliophagus and other Ditylenchus species; awl nematodes, Dolichodorus species; spiral nematodes, Helicotylenchus dihystera, Helicotylenchus multicinctus and other Helicotylenchus species, Rotylenchus robustus and other Rotylenchus species; sheath nematodes, Hemicycliophora species and Hemicriconemoides species; Hirshmanniella species; lance nematodes, Hoplolaimus columbus, Hoplolaimus galeatus and other Hoplolaimus species; false root-knot nematodes, Nacobbus aberrans and other Nacobbus species; needle nematodes, Longidorus elongates and other Longidorus species; pin nematodes, Paratylenchus species; lesion nematodes, Pratylenchus brachyurus, Pratylenchus coffeae, Pratylenchus curvitatus, Pratylenchus goodeyi, Pratylencus neglectus, Pratylenchus penetrans, Pratylenchus scribneri, Pratylenchus vulnus, Pratylenchus zeae and other Pratylenchus species; Radinaphelenchus cocophilus and other Radinaphelenchus species; burrowing nematodes, Radopholus similis and other Radopholus species; reniform nematodes, Rotylenchulus reniformis and other Rotylenchulus species; Scutellonema species; stubby root nematodes, Trichodorus primitivus and other Trichodorus species; Paratrichodorus minor and other Paratrichodorus species; stunt nematodes, Tylenchorhynchus claytoni, Tylenchorhynchus dubius and other Tylenchorhynchus species and Merlinius species; citrus nematodes, Tylenchulus semipenetrans and other Tylenchulus species; dagger nematodes, Xiphinema americanum, Xiphinema index, Xiphinema diversicaudatum and other Xiphinema species; and other plant parasitic nematode species.

In a preferred embodiment, the insect is selected from foliar insect pests.

In another preferred embodiment, the insect is selected from the order Coleoptera, preferably from the family Chrysomelidae and is in particular Leptinotarsa decemlineata. According to another preferred embodiment, the insect of the order Coleoptera is selected from the family Curculionidae, preferably from Tanymecus spp. and is in particular Tanymecus palliatus.

In another preferred embodiment, the insect is selected from sucking insects, in particular from lygus bugs, aphids and whiteflies.

In another preferred embodiment, the insect is selected from the order Lepidoptera.

In another preferred embodiment, the insect pest is selected from Lepidopteran rice stemborers, rice skippers, rice cutworms, rice armyworms, rice caseworms and rice leaffolders. In particular, the insect is selcted from Chilo suppressalis, Scirpophaga incertulas, Sesamia inferens, Cnaphalocrocis medinalis, Hereitogramma licarisalis, Naranga aenescens, Mycalesis gotama, Marasmia patnalis, Marasmia exigua, Marasmia ruralis, Nymphula depunctalis, Scirpophaga innotata, Spodoptera litura, Chilo polychrysus, Rupela albinella, Diatraea saccharalis, Spodoptera frugiperda, Mythimna unipuncta, Chilo zacconius and Parnara guttata.

In another preferred embodiment, the insect is selected from the order Hemiptera.

In another preferred embodiment, the insect pest is selected from planthoppers (Delphacidae) and leafhoppers (Deltocephalidae). Among the planthoppers, the smaller brown planthopper (Laodelphax striatellus), brown planthopper (Nilaparvata lugens) and white-backed rice planthopper (Sogatella furcifera) are preferred target insects. Among the leafhoppers, green rice leafhoppers (Nephotettix cincticeps, Nephotettix nigropictus and Nephotettix virescens) are preferred target insects.

In another preferred embodiment, the insect is selected from the order Diptera, more preferably from the family Tephritidae and is in particular Ceratitis capitata.

According to a particular embodiment, the target pest for the seed treatment of the present invention is an insect pest, preferably a dipteran pest, more preferably a root fly or a root maggot. Those belonging to the family Anthomyiidae, and more preferably those belonging to any of the genera Psila, Delia, Phorbia, Hylemia and Pegomya represent particular target pests of the present invention.

The present seed treatment can be used to control said target pests and/or to protect the seeds, roots and/or the above-ground parts of field, forage, plantation, glasshouse, orchard or vineyard crops, ornamentals, plantation or forest trees and/or any other plant(s) of interest. The seeds that are useful in the present invention can be the seeds of any plant species.

In particular, the seeds can be of tuberous and corm vegetables, such as arracacha, arrowroot, artichoke, canna, cassava, carrot, chayote root, chufa, dasheen, ginger, leren, onion, potato, radish, tanier, turmeric, yam bean, true yam; leafy vegetables, such as amaranth, arugula, cardoon, celery, celtuce, chervil, chrysanthemum, cress, dandelion, dock, endive, fennel, kale, leek, lettuce, orach, parsley, purslane, radicchio, rhubarb, spinach, swiss chard, tampala, head and stem brassica, such as broccoli, brussels sprout, cabbage, cauliflower, cavalo broccolo, curly cale, kohlrabi; leafy brassica greens, such as broccoli raab, cabbage, collards, kale, mizuna, mustard greens, mustard spinach, rape greens; fruiting vegetables such as beans, chili, postharvest, eggplant, groundcherry, pepino, pea, pepper, tomatillo, tomato. It is preferred that the seed be broccoli, carrot, cabbage, especially chinese cabbage, red cabbage, savoy cabbage, white cabbage, celery, cauliflower, kohlrabi and radish seeds.

It is most preferred if the pest belongs to the Anthomyiidae, in particular to any of the genera Psila, Delia, Phorbia, Hylemia and Pegomya, and the seed is a broccoli seed, a cabbage seed or a carrot seed.

The invention therefore also relates to a method for protecting tuberous or corm vegetables, leafy vegetables, leafy brassica greens, fruiting vegetables, especially broccoli, carrots and cabbage.

For use according to the present invention, the mixtures according to the invention, or the compound I and the active compound II, can be converted into customary formulations, for example solutions, emulsions, suspensions, dusts, powders, pastes and granules. The use form depends on the particular intended purpose; in each case, it should ensure a fine and even distribution of the compound according to the invention.

The formulations are prepared in a known manner, for example by extending the active compounds with solvents and/or carriers, if desired using emulsifiers and dispersants. Solvents/auxiliaries which are suitable are essentially:
water, aromatic solvents (for example Solvesso products, xylene), paraffins (for example mineral oil fractions), alcohols (for example methanol, butanol, pentanol, benzyl alcohol), ketones (for example cyclohexanone, gamma-butyrolactone), pyrrolidones (NMP, NOP), acetates (glycol diacetate), glycols, fatty acid dimethylamides, fatty acids and fatty acid esters. In principle, solvent mixtures may also be used,
carriers such as ground natural minerals (for example kaolins, clays, talc, chalk) and ground synthetic minerals (for example highly disperse silica, silicates); emulsifiers such as nonionic and anionic emulsifiers (for example polyoxyethylene fatty alcohol ethers, alkylsulfonates and arylsulfonates) and dispersants such as lignosulfite waste liquors and methylcellulose.

Suitable surfactants are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenol ethers, ethoxylated isooctylphenol, octylphenol, nonylphenol, alkylphenol polyglycol ethers, tributylphenyl polyglycol ethers, tristearylphenyl polyglycol ethers, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, strongly polar solvents, for example dimethyl sulfoxide, N-methylpyrrolidone and water.

Also anti-freezing agents such as glycerin, ethylene glycol, propylene glycol and bactericides such as can be added to the formulation.

Suitable antifoaming agents are for example antifoaming agents based on silicon or magnesium stearate.

Suitable preservatives are for example Dichlorophen and enzylalkoholhemiformal.

Seed Treatment formulations may additionally comprise binders and optionally colorants.

Binders can be added to improve the adhesion of the active materials on the seeds after treatment. Suitable binders are block copolymers EO/PO surfactants but also polyvinylalcohols, polyvinylpyrrolidones, polyacrylates, polymethacrylates, polybutenes, polyisoutylenes, polystyrene, polyethyleneamines, polyethyleneamides, polyethyleneimines (Lupasol®, Polymin®), polyethers, polyurethans, polyvinylacetate, tylose and copolymers derived from these polymers.

Optionally, also colorants can be included in the formulation. Suitable colorants or dyes for seed treatment formulations are Rhodamin B, C.I. Pigment Red 112, C.I. Solvent Red 1, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

Examples of a gelling agent is carrageen (Satiagel®).

Powders, materials for spreading and dustable products can be prepared by mixing or concomitantly grinding the active substances with a solid carrier.

Granules, for example coated granules, impregnated granules and homogeneous granules, can be prepared by binding the active compounds to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the active compound. The active compounds are employed in a purity of from 90% to 100%, preferably 95% to 100% (according to NMR spectrum).

For seed treatment purposes, respective formulations can be diluted 2-10 fold leading to concentrations in the ready to use preparations of 0.01 to 60% by weight active compound by weight, preferably 0.1 to 40% by weight.

The following are examples of formulations: 1. Products for dilution with water For seed treatment purposes, such products may be applied to the seed diluted or undiluted.

A) Water-Soluble Concentrates (SL, LS)

10 parts by weight of the active compounds are dissolved with 90 parts by weight of water or a water-soluble solvent. As an alternative, wetters or other auxiliaries are added. The active compound dissolves upon dilution with water. A formulation having an active compound content of 10% by weight is obtained in this manner.

B) Dispersible Concentrates (DC)

20 parts by weight of the active compounds are dissolved in 70 parts by weight of cyclohexanone with addition of 10 parts by weight of a dispersant, for example polyvinylpyrrolidone. Dilution with water gives a dispersion. The active compound content is 20% by weight.

C) Emulsifiable Concentrates (EC)

15 parts by weight of the active compounds are dissolved in 75 parts by weight of xylene with addition of calcium dodecylbenzenesulfonate and castor oil ethoxylate (in each case 5 parts by weight). Dilution with water gives an emulsion. The formulation has an active compound content of 15% by weight.

D) Emulsions (EW, EO, ES)

25 parts by weight of the active compounds are dissolved in 35 parts by weight of xylene with addition of calcium dodecylbenzenesulfonate and castor oil ethoxylate (in each case 5 parts by weight). This mixture is added into 30 parts by weight of water by means of an emulsifying machine (e.g. Ultraturrax) and made into a homogeneous emulsion. Dilution with water gives an emulsion. The formulation has an active compound content of 25% by weight.

E) Suspensions (SC, OD, FS)

In an agitated ball mill, 20 parts by weight of the active compounds are comminuted with addition of 10 parts by weight of dispersants and wetters and 70 parts by weight of water or an organic solvent to give a fine active compound suspension. Dilution with water gives a stable suspension of the active compound. The active compound content in the formulation is 20% by weight.

F) Water-Dispersible Granules and Water-Soluble Granules (WG, SG)

50 parts by weight of the active compounds are ground finely with addition of 50 parts by weight of dispersants and wetters and made into water-dispersible or water-soluble granules by means of technical appliances (for example extrusion, spray tower, fluidized bed). Dilution with water gives a stable dispersion or solution of the active compound. The formulation has an active compound content of 50% by weight.

G) Water-Dispersible Powders and Water-Soluble Powders (WP, SP, SS, WS)

75 parts by weight of the active compounds are ground in a rotor-stator mill with addition of 25 parts by weight of dispersants and wetters as well as silica gel. Dilution with water gives a stable dispersion or solution of the active compound. The active compound content of the formulation is 75% by weight.

H) Gel Formulations (GF)

In a ball mill, 20 parts by weight of the active compounds, 10 parts by weight of dispersant, 1 part by weight of gelling agent and 70 parts by weight of water or an organic solvent are ground to give a fine suspension. On dilution with water, a stable suspension having an active compound content of 20% by weight is obtained.

2. Products to be Applied Undiluted

I) Dustable Powders (DP, DS)

5 parts by weight of the active compounds are ground finely and mixed intimately with 95 parts by weight of finely divided kaolin. This gives a dustable product having an active compound content of 5% by weight.

J) Granules (GR, FG, GG, MG)

0.5 part by weight of the active compounds is ground finely and associated with 99.5 parts by weight of carriers. Current methods are extrusion, spray-drying or the fluidized bed. This gives granules to be applied undiluted having an active compound content of 0.5% by weight.

K) ULV Solutions (UL)

10 parts by weight of the active compounds are dissolved in 90 parts by weight of an organic solvent, for example xylene. This gives a product to be applied undiluted having an active compound content of 10% by weight.

For seed treatment, use is usually made of water-soluble concentrates (LS), suspensions (FS), dustable powders (DS), water-dispersible and water-soluble powders (WS, SS), emulsions (ES), emulsifiable concentrates (EC) and gel formulations (GF). These formulations can be applied to the seed in undiluted form or, preferably, diluted. Application can be carried out prior to sowing.

In a preferred embodiment a FS formulation is used for seed treatment. Typcially, a FS formulation may comprise 1-800 g/l of active ingredient, 1-200 g/l Surfactant, 0 to 200 g/l antifreezing agent, 0 to 400 g/l of binder, 0 to 200 g/l of a pigment and up to 1 liter of a solvent, preferably water.

The active compounds can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; the intention is to ensure in each case the finest possible distribution of the active compounds according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. Alternatively, it is possible to prepare concentrates composed of active substance, wetter, tackifier, dispersant or emulsifier and, if appropriate, solvent or oil, and such concentrates are suitable for dilution with water.

The active compound concentrations in the ready-to-use preparations can be varied within relatively wide ranges. In general, they are from 0.0001 to 10%, preferably from 0.01 to 1%.

The active compounds may also be used successfully in the ultra-low-volume process (ULV), by which it is possible to apply formulations comprising over 95% by weight of active compound, or even to apply the active compound without additives.

Various types of oils, wetters, adjuvants, herbicides, fungicides, other pesticides, or bactericides may be added to the active compounds, if appropriate not until immediately prior to use (tank mix). These agents can be admixed with the agents according to the invention in a weight ratio of 1:100 to 100:1, preferably 1:10 to 10:1.

Compositions of this invention may also contain other active ingredients, for example other pesticides, insecticides, herbicides, fertilizers such as ammonium nitrate, urea, potash, and superphosphate, phytotoxicants and plant growth regulators, safeners and nematicides. These additional ingredients may be used sequentially or in combination with the above-described compositions, if appropriate also added only immediately prior to use (tank mix). These agents can be admixed with the mixtures according to the invention in a weight ratio of 1:10 to 10:1. For example, the plant(s) may be sprayed with a composition of this invention either before or after being treated with other active ingredients.

The mixtures and methods according to the invention are particularly useful for the control of pests. The inventive mixtures are suitable for efficiently controlling insects, acarids and nematodes. They can be applied to any and all developmental stages, such as egg, larva, pupa, and adult.

The pests may be controlled by contacting the pest itself, its food supply, habitat, breeding ground or its locus with a pesticidally effective amount of the inventive mixtures or of compositions comprising the mixtures.

“Locus” means a plant, seed, soil, area, material or environment in which a pest is growing or may grow.

In general, “pesticidally effective amount” means the amount of the inventive mixtures or of compositions comprising the mixtures needed to achieve an observable effect on growth, including the effects of necrosis, death, retardation, prevention, and removal, destruction, or otherwise diminishing the occurrence and activity of the target organism. The pesticidally effective amount can vary for the various mixtures/compositions used in the invention. A pesticidally effective amount of the mixtures/compositions will also vary according to the prevailing conditions such as desired pesticidal effect and duration, weather, target species, locus, mode of application, and the like.

The inventive mixtures or compositions of these mixtures can also be employed for protecting plants from attack or infestation by insects, acarids or nematodes comprising contacting a plant, or soil or water in which the plant is growing.

As used herein, the term “pest” is considered to include any harmful organisms including insects, acarids, and nematodes.

In the context of the present invention, the term “plant” refers to an entire plant, a part of the plant or the propagation material of the plant, such as the seed, the seed piece, the transplant, the seedling, or the cutting.

In a preferred embodiment, the plant is selected from fruit-bearing plants, potato, rice, cotton and horticultural plants. Fruit bearing plants of the invention include the major types of fruit for example, berries such as grapes, blueberries; drupes such as peaches, cherries, olives, plums and walnuts; aggregate fruit such as blackberries and raspberries; multiple fruit such as pineapples, figs and mulberries; and accessory fruit such as apples, pears and strawberries, and citrus fruit such as oranges, grapefruit, kumquats, lemons, limes, tangerines, temples, citrange, tangelo, pomelo, and citron.

Plants which can be treated with the inventive mixtures include all genetically modified plants or transgenic plants, e.g. crops which tolerate the action of herbicides or fungicides or insecticides owing to breeding, including genetic engineering methods, or plants which have modified characteristics in comparison with existing plants, which can be generated for example by traditional breeding methods and/or the generation of mutants, or by recombinant procedures.

Some of the inventive mixtures have systemic action and can therefore be used for the protection of the plant shoot against foliar pests as well as for the treatment of the seed and roots against soil pests. The term seed treatment comprises all suitable seed treatment techniques known in the art, such as seed dressing, seed coating, seed dusting, seed soaking and seed pelleting.

It will be appreciated from the above, that the compounds I and II can be applied simultaneously, that is jointly (e.g. in the same formulation) or separately (e.g. in different formulations, such as in kit form), or in succession. If there is a successive application, it will also be appreciated that the subsequently applied compounds I and II should be applied to a subject (e.g. the pest, plant or animal) within a time scale so as to achieve or optimize the above referred to advantageous synergistic effect.

The compounds (I) and the compound (II) are usually applied in a weight ratio of from 500:1 to 1:6000, preferably from 20:1 to 1:50, especially from 10:1 to 1:10, in particular from 5:1 to 1:20, very particularly between 5:1 to 1:5, particularly preferably between 2:1 and 1:2, also preferably between 4:1 and 2:1, mainly in the ratio of 1:1, or 5:1, or 5:2, or 5:3, or 5:4, or 4:1, or 4:2, or 4:3, or 3:1, or 2:1, or 1:5, or 2:5, or 3:5, or 4:5, or 1:4, or 2:4, or 3:4, or 1:3, or 2:3, or 1:2, or 1:600, or 1:300, or 1:150, or 1:35, or 2:35, or 4:35, or 1:75, or 2:75, or 3:75, or 4:75, or 1: 6000, or 1: 3000, or 1:1500, or 1:350, or 2:350, or 3:350, or 4:350, or 1:750, or 2:750, or 3:750, or 4:750.

Depending on the desired effect, the application rates of the mixtures according to the invention are from 5 g/ha to 2000 g/ha, preferably from 50 to 1500 g/ha, in particular from 50 to 750 g/ha.

The inventive mixtures are also suitable for the protection of the seed and the seedlings' roots and shoots, against soil pests.

Conventional seed treatment formulations include for example flowable concentrates FS, solutions LS, powders for dry treatment DS, water dispersible powders WS or granules for slurry treatment, water soluble powders SS and emulsion ES. Application to the seeds is carried out before sowing, either directly on the seeds or after having pregerminated the latter, at sowing or after sowing. Preferred are FS formulations.

In the treatment of seed, the application rates of the inventive mixture are generally from 0.1 to 10 kg per 100 kg of seeds, in particular from 1 g to 2 kg per 100 kg of seeds. The separate or joint application of the compounds I and II or of the mixtures of the compounds I and II is carried out by spraying or dusting the seeds, the seedlings, the plants or the soils before or after sowing of the plants or before or after emergence of the plants.

The invention also relates to the propagation products of plants, and especially the seed comprising, that is, coated with and/or containing, a mixture as defined above or a composition containing the mixture of two or more active ingredients or a mixture of two or more compositions each providing one of the active ingredients. The seed comprises the inventive mixtures in an amount of from 0.1 g to 10 kg per 100 kg, preferably from 1 g to 5 kg per 100 kg, most preferably from 1 g to 2.5 kg per 100 kg of seed.

The inventive mixtures are effective through both contact (via soil, glass, wall, bed net, carpet, plant parts or animal parts), and ingestion (bait, or plant part) and through trophallaxis and transfer.

Preferred application methods are into water bodies, the soil, cracks and crevices, pastures, manure piles, sewers, into water, on floor, wall, or by perimeter spray application and bait.

According to a preferred embodiment of the invention, the inventive mixtures are employed via soil application. Soil application is especially favorable for use against ants, termites, flies, crickets, grubs, root weevils, root beetles or nematodes.

According to another preferred embodiment of the invention, for use against non crop pests such as ants, termites, wasps, flies, mosquitoes, crickets, locusts, or cockroaches the inventive mixtures are prepared into a bait preparation.

The bait can be a liquid, a solid or a semisolid preparation (e.g. a gel). The bait employed in the composition is a product which is sufficiently attractive to incite insects such as ants, termites, wasps, flies, mosquitoes, crickets etc. or cockroaches to eat it. This attractant may be chosen from feeding stimulants or para and/or sex pheromones. Suitable feeding stimulants are chosen, for example, from animal and/or plant proteins (meat-, fish- or blood meal, insect parts, crickets powder, egg yolk), from fats and oils of animal and/or plant origin, or mono-, oligo- or polyorganosaccharides, especially from sucrose, lactose, fructose, dextrose, glucose, starch, pectin or even molasses or honey, or from salts such as ammonium sulfate, ammonium carbonate or ammonium acetate. Fresh or decaying parts of fruits, crops, plants, animals, insects or specific parts thereof can also serve as a feeding stimulant. Pheromones are known to be more insect specific. Specific pheromones are described in the literature and are known to those skilled in the art.

Formulations of the inventive mixtures as aerosols (e.g in spray cans), oil sprays or pump sprays are highly suitable for the non-professional user for controlling pests such as flies, fleas, ticks, mosquitoes, locusts or cockroaches. Aerosol recipes are preferably composed of the active mixture, solvents such as lower alcohols (e.g. methanol, ethanol, propanol, butanol), ketones (e.g. acetone, methyl ethyl ketone), paraffin hydrocarbons (e.g. kerosenes) having boiling ranges of approximately 50 to 250° C., dimethylformamide, N-methylpyrrolidone, dimethyl sulphoxide, aromatic hydrocarbons such as toluene, xylene, water, furthermore auxiliaries such as emulsifiers such as sorbitol monooleate, oleyl ethoxylate having 3-7 mol of ethylene oxide, fatty alcohol ethoxylate, perfume oils such as ethereal oils, esters of medium fatty acids with lower alcohols, aromatic carbonyl compounds, if appropriate stabilizers such as sodium benzoate, amphoteric surfactants, lower epoxides, triethyl orthoformate and, if required, propellants such as propane, butane, nitrogen, compressed air, dimethyl ether, carbon dioxide, nitrous oxide, or mixtures of these gases.

The oil spray formulations differ from the aerosol recipes in that no propellants are used.

The inventive mixtures and their respective compositions can also be used in mosquito coils and fumigating coils, smoke cartridges, vaporizer plates, long-term vaporizers, or other heat-independent vaporizer systems.

Methods to control infectious diseases transmitted by insects (e.g. malaria, dengue and yellow fever, lymphatic filariasis, and leishmaniasis) with the inventive mixtures and their respective compositions also comprise treating surfaces of huts and houses, air spraying and impregnation of curtains, tents, clothing items, bed nets, tsetse-fly trap or the like. Insecticidal compositions for application to fibers, fabric, knitgoods, nonwovens, netting material or foils and tarpaulins preferably comprise a mixture including the insecticide, optionally a repellent and at least one binder.

The inventive mixtures and the compositions comprising them can be used for protecting wooden materials such as trees, board fences, sleepers, etc. and buildings such as houses, outhouses, factories, but also construction materials, furniture, leathers, fibers, vinyl articles, electric wires and cables etc. from ants and/or termites, and for controlling ants and termites from doing harm to crops or human being (e.g. when the pests invade into houses and public facilities). The inventive mixtures are applied not only to the surrounding soil surface or into the under-floor soil in order to protect wooden materials but it can also be applied to lumbered articles such as surfaces of the under-floor concrete, alcove posts, beams, plywoods, furniture, etc., wooden articles such as particle boards, half boards, etc. and vinyl articles such as coated electric wires, vinyl sheets, heat insulating material such as styrene foams, etc. In case of application against ants doing harm to crops or human beings, the ant control composition of the present invention is directly applied to the nest of the ants or to its surrounding or via bait contact. The compounds or compositions of the inventive mixtures can also be applied preventively to places at which occurrence of the pests is expected.

In the case of soil treatment or of application to the pests dwelling place or nest, the quantity of the mixture of the active ingredients ranges from 0.0001 to 500 g per 100 m², preferably from 0.001 to 20 g per 100 m².

Customary application rates in the protection of materials are, for example, from 0.01 g to 1000 g of the mixture of the active compounds per m²treated material, desirably from 0.1 g to 50 g per m².

Insecticidal compositions for use in the impregnation of materials typically contain from 0.001 to 95 weight %, preferably from 0.1 to 45 weight %, and more preferably from 1 to 25 weight % of the mixture of the active ingredients.

For use in bait compositions, the typical content of the mixture of active ingredients is from 0.0001 weight % to 15 weight %, desirably from 0.001 weight % to 5% weight % of active compounds. The composition used may also comprise other additives such as a solvent of the active materials, a flavoring agent, a preserving agent, a dye or a bitter agent. Its attractiveness may also be enhanced by a special color, shape or texture.

For use in spray compositions, the content of the mixture of the active ingredients is from 0.001 to 80 weights %, preferably from 0.01 to 50 weight % and most preferably from 0.01 to 15 weight %.

For use in treating crop plants, the rate of application of the mixture of the active ingredients of this invention may be in the range of 0.1 g to 4000 g per hectare, desirably from 25 g to 600 g per hectare, more desirably from 50 g to 500 g per hectare.

It was also an object of the present invention to provide mixtures suitable for treating, controlling, preventing and protecting warm-blooded animals, including humans, and fish against infestation and infection by pests. Problems that may be encountered with pest control on or in animals and/or humans are similar to those described at the outset, namely the need for reduced dosage rates, and/or enhanced spectrum of activity and/or combination of knock-down activity with prolonged control and/or resistance management.

This invention also provides a method for treating, controlling, preventing and protecting warm-blooded animals, including humans, and fish against infestation and infection by pests of the orders Siphonaptera, Hymenoptera, Hemiptera, Orthoptera, Acarina, Phthiraptera, and Diptera, which comprises orally, topically or parenterally administering or applying to said animals a pesticidally effective amount of mixtures according to the invention.

The invention also provides a process for the preparation of a composition for treating, controlling, preventing or protecting a warm-blooded animal or a fish against infestation or infection by pests of the Siphonaptera, Hymenoptera, Hemiptera, Orthoptera, Acarina, Phthiraptera, and Diptera orders which comprises a pesticidally effective amount of a mixture according to the invention.

The above method is particularly useful for controlling and preventing infestations and infections in warm-blooded animals such as cattle, sheep, swine, camels, deer, horses, poultry, goats, dogs and cats as well as humans.

Infestations in warm-blooded animals and fish including, but not limited to, lice, biting lice, ticks, nasal bots, keds, biting flies, muscoid flies, flies, myiasitic fly larvae, chiggers, gnats, mosquitoes and fleas may be controlled, prevented or eliminated by the mixtures according to the invention.

For oral administration to warm-blooded animals, the mixtures according to the invention may be formulated as animal feeds, animal feed premixes, animal feed concentrates, pills, solutions, pastes, suspensions, drenches, gels, tablets, boluses and capsules. In addition, the mixtures according to the invention may be administered to the animals in their drinking water. For oral administration, the dosage form chosen should provide the animal with 0.01 mg/kg to 100 mg/kg of animal body weight per day of the mixture.

Alternatively, the mixtures according to the invention may be administered to animals parenterally, for example, by intraruminal, intramuscular, intravenous or subcutaneous injection. The mixtures according to the invention may be dispersed or dissolved in a physiologically acceptable carrier for subcutaneous injection. Alternatively, the mixtures according to the invention may be formulated into an implant for subcutaneous administration. In addition the mixtures according to the invention may be transdermally administered to animals. For parenteral administration, the dosage form chosen should provide the animal with 0.01 mg/kg to 100 mg/kg of animal body weight per day of the mixture.

The mixtures according to the invention may also be applied topically to the animals in the form of dips, dusts, powders, collars, medallions, sprays, spot-on and pour-on formulations. For topical application, dips and sprays usually contain 0.5 ppm to 5,000 ppm and preferably 1 ppm to 3,000 ppm of the inventive compounds. In addition, the mixtures according to the invention may be formulated as ear tags for animals, particularly quadrupeds such as cattle and sheep.

Accordingly, in a further aspect of the invention there is provided the use of a mixture according to the invention in the preparation of a veterinary medicament, specifically an antiparasiticidal medicament.

The synergistic action of the mixtures according to the invention was demonstrated by the experiments below.

### USE EXAMPLES

Synergism can be described as an interaction where the combined effect of two or more compounds is greater than the sum of the individual effects of each of the compounds. The presence of a synergistic effect in terms of percent control, between two mixing partners (X and Y) can be calculated using the Colby equation (Colby, S. R., 1967, Calculating Synergistic and Antagonistic Responses in Herbicide Combinations, Weeds, 15, 20-22):

$$E = \frac{XY}{100}$$

When the observed combined control effect is greater than the expected combined control effect (E), then the combined effect is synergistic.

The following tests demonstrate the control efficacy of mixtures or compositions of this invention on specific pests. However, the pest control protection afforded by the mixtures or compositions of this invention is not limited to these species. In certain instances, mixtures or compositions of this invention are found to exhibit synergistic effects against certain other important invertebrate pests.

The analysis of synergism or antagonism between the mixtures or compositions according to this invention was determined using Colby's equation.

### Example 1

For evaluating control of Mediterranean fruitfly (Ceratitis capitata) the test unit consisted of 96-well-microtiter plates containing an insect diet and 50-80 C. capitata eggs. The compounds or mixtures were formulated using a solution containing 75% water and 25% DMSO. Different concentrations of formulated compounds or mixtures were sprayed onto the insect diet at 5 μl, using a custom built micro atomizer, at two replications.

For experimental mixtures in these tests identical volumes of both mixing partners at the desired concentrations respectively, were mixed together.

After application, microtiter plates were incubated at 28±1° C., 80±5% RH (relative humidity) for 5 days. Egg and larval mortality was then visually assessed. For the mixture tested the results are listed in Table 1.

TABLE 1
Synergistic activity in Mediterranean fruitfly control

| Active compound/ | Concentration | Average |
|---|---|---|
| active compound mixture | (ppm) | Control (%) |
| Clothianidin | 2 | 0 |
| Metaflumizone* | 20 | 0 |
| Clothianidin + Metaflumizone* | 2 + 20 | 75** |

*Compound Ia
**synergistic control effect according to Colby's equation

1-40. (canceled)

41. A pesticidal mixture comprising, as active components,
1) a compound of the formula I 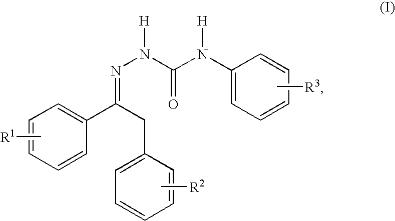
wherein R¹ and R² are each independently hydrogen, halogen, cyano, C₁-C₄ alkyl, C₁-C₄ alkoxy, C₁-C₄ haloalkyl or C₁-C₄ haloalkoxy and R³ is C₁-C₄ alkoxy, C₁-C₄ haloalkyl or C₁-C₄ haloalkoxy, or an agriculturally acceptable salt thereof; and
2) a compound of the formula II 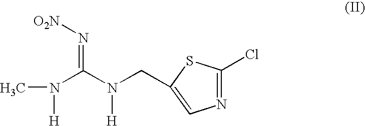
or its agriculturally acceptable salts, in synergistically effective amounts.

42. The pesticidal mixture according to claim 41, wherein the compound of formula I is 2-[2-(4-cyanophenyl)-1-[3-(trifluoromethyl)phenyl]ethylidene]-N-[4-(trifluoromethoxy)phenyl]hydrazinecarboxamide.

43. The pesticidal mixture according to claim 41, comprising the compound of the formula I and the compound of the formula II in a weight ratio of from 100:1 to 1:100.

44. A pesticidal composition, comprising a liquid or solid carrier and the mixture of claim 41.

45. A process for preparing the composition of claim 44, said process comprising the step of extending the compounds I and II with a liquid or solid carrier.

46. A method for controlling insects, arachnids or nematodes comprising contacting the insect, arachnid or nematode or their food supply, habitat, breeding grounds or their locus with a composition comprising the mixture of claim 41 in a pesticidally effective amount.

47. A method for protecting plants from attack or infestation by insects, arachnids or nematodes comprising contacting a plant, or soil or water in which the plant is growing, with a composition comprising the mixture of claim 41 in pesticidally effective amounts.

48. The method of claim 47, wherein the plant is selected from the group consisting of fruit-bearing plants, potato, rice, cotton and horticultural plants.

49. The method of claim 46, wherein the insect is selected from foliar insect pests.

50. The method of claim 46, wherein the insect is selected from the order Diptera.

51. The method of claim 50, wherein the insect of the order Diptera is selected from the family Tephritidae.

52. The method of claim 51, wherein the insect is Ceratitis capitata.

53. The method of claim 46, wherein the insect is of the order Coleoptera.

54. The method of claim 53, wherein the insect of the order Coleoptera is selected from the family Chrysomelidae.

55. The method of claim 54, wherein the insect is Leptinotarsa decemlineata.

56. The method of claim 53, wherein the insect of the order Coleoptera is selected from the family Curculionidae.

57. The method of claim 56, wherein the insect is selected from Tanymecus spp.

58. The method of claim 46, wherein the insect is selected from sucking insects.

59. The method of claim 58, wherein the sucking insects are selected from the group consisting of lygus bugs, aphids and whiteflies.

60. The method of claim 46, wherein the insect is selected from the order Lepidoptera or Hemiptera.

61. The method of claim 60, wherein the insect is selected from the group consisting of Lepidopteran rice stemborers, rice skippers, rice cutworms, rice armyworms, rice caseworms and rice leaffolders.

62. The method of claim 60, wherein the insect is selected from the group consisting of planthoppers (Delphacidae) and leafhoppers (Deltocephalidae).

63. The method of claim 46, wherein the composition is applied in an amount of from 5 g/ha to 2000 g/ha.

64. A method of protection of seeds comprising contacting the seeds before sowing and/or after pregermination with the mixture of claim 41 in pesticidally effective amounts.

65. The method of claim 64, wherein the seeds are protected from an insect pest.

66. The method of claim 65, wherein the insect pest is of the order Lepidoptera.

67. The method of claim 65, wherein the insect pest is of the order Diptera.

68. The method of claim 67, wherein the dipteran pest is a root fly or root maggot.

69. The method of claim 68, wherein the root fly or root maggot is a member of the family Anthomyiidae.

70. The method of claim 69, wherein the root fly or root maggot is selected from the group consisting of the genera Delia, Hylemia, Pegomya, Phorbia and Psila.

71. The method of claim 64, wherein the seeds are of a tuberous or corn vegetable, a leafy vegetable, a leafy brassica green, or a fruiting vegetable.

72. The method of claim 64, wherein the seed is of broccoli, carrot or cabbage.

73. The method of claim 64, wherein the mixture is applied in an amount of from 0.1 g to 10 kg per 100 kg of seeds.

74. The method of claim 73, wherein the mixture is applied in an amount of from 1 g to 2 kg per 100 kg of seeds.

75. A seed, comprising the mixture of claim 41 in an amount of from 0.1 g to 10 kg per 100 kg of seeds.

76. A method for treating, controlling, preventing or protecting a warm-blooded animal or a fish against infestation or infection by pests which comprises orally, topically or parenterally administering or applying to said animal or fish a pesticidally effective amount of the mixture of claim 41.
